(19) United States
(12) Patent Application Publication
(10) Pub. No.: US 2019/0054976 A1
(43) Pub. Date: Feb. 21, 2019

(54) EFFORT-SAVING BICYCLE

(71) Applicant: CHIN AN CHANG, Taoyuan County (TW)

(72) Inventor: CHIN AN CHANG, Taoyuan County (TW)

(21) Appl. No.: 15/677,838

(22) Filed: Aug. 15, 2017

(51) Int. Cl. B62M 3/06; B62M 9/02

(52) U.S. Cl. CPC B62M 3/06; B62M 9/02

(57) ABSTRACT

An effort-saving bicycle is provided. The bicycle includes at least one wheel. The wheel is centrality provided with a shaft gear at its rim. The shaft gear is connected to a chain that is further connected to a transmission gear. The transmission gear has its shaft connected to one end of a first crank whose opposite end acts as a first crank joint connected to a link's one end at its inner side. The link has its opposite end provided with a pedal. The first crank joint of the link is connected to one end of a second crank through a second crank joint whose opposite end is connected to a second crank-frame joint that is connected to a frame. The specially located transmission gear working with the extended links that connects cranks and pedals allows effort-saving bicycling based on the lever rule.

### BACKGROUND OF THE INVENTION

### 1. Technical Field

The present invention relates to bicycled, and more particularly to an effort-saving bicycle using extended links connected cranks of a conventional bicycle so as to allow effort-saving bicycling.

### 2. Description of Related Art

Since the invention of bicycles, the improvements have been focused on derailleurs but not pedaling efficiency due to the limitation of cranks' structural length. Hence, there is a need to improve pedaling efficiency and allow more effort-saving bicycling.

### SUMMARY OF THE INVENTION

For breaking through the structural limitation of existing bicycles, the present invention provides an effort-saving bicycle. It moves the transmission gear from below the feet as arranged traditionally to the upper rear of the rear wheel, and uses an extended link that has one end connect to a crank and an opposite end provide with a pedal. When a force exerted through the pedal, the link acts as a lever, so as to allow effort-saving bicycling based on the level rule.

According to the present invention, the bicycle comprises a wheel. The wheel is centrality provided with a shaft gear at its rim. The shaft gear is connected to a chain. The chain is connected to a transmission gear. The transmission gear has a shaft connected to one end of a first crank. The first crank has an opposite end acting as a first crank joint. The first crank joint is connected to one end of a link at the link's inner side. The link has its opposite end provided with a pedal. The first crank joint of the link has its outer side connected to one end of a second crank through a second crank joint. The second crank has an opposite end connected to a second crank-frame joint, and the second crank-frame joint is connected to a frame. The frame has a roughly U-like shape and flanks two sides of the wheel. The link, the first crank, the second crank, and the pedal form a set and each of two sides of the wheel is provided with one side set. The transmission gear is located at one side and the upper rear of the wheel.

The present invention provides the following advantages:

In the present invention, the specially located transmission gear working with the extended link that connects two cranks allows effort-saving bicycling based on the lever rule.

### BRIEF DESCRIPTION OF THE DRAWINGS

FIG. 1 is a side view of the present invention.

FIG. 2 is a top view of the present invention.

### DETAILED DESCRIPTION OF THE INVENTION

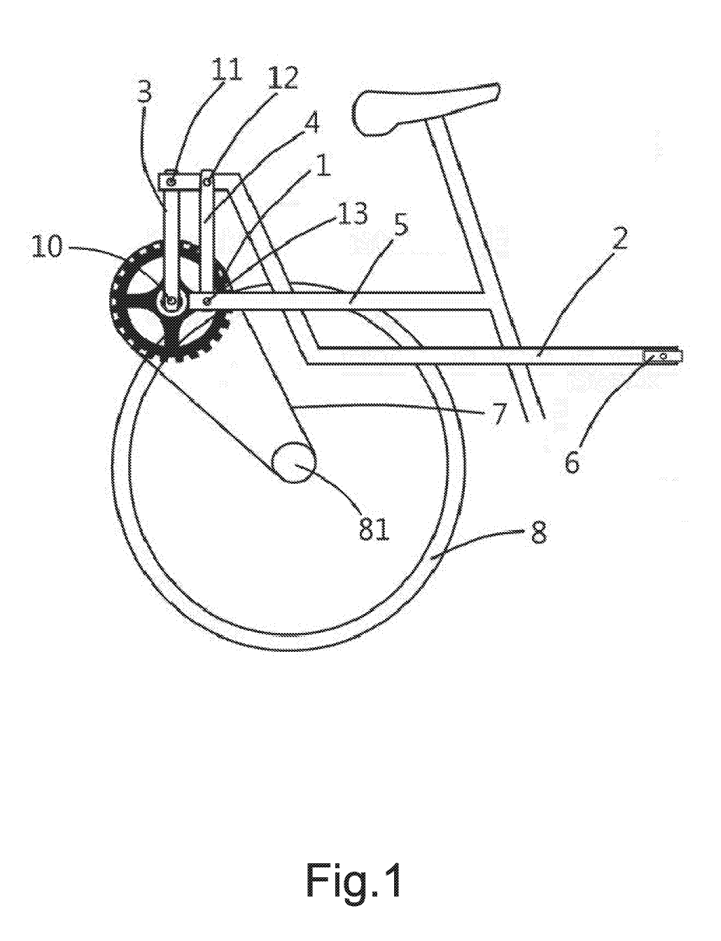

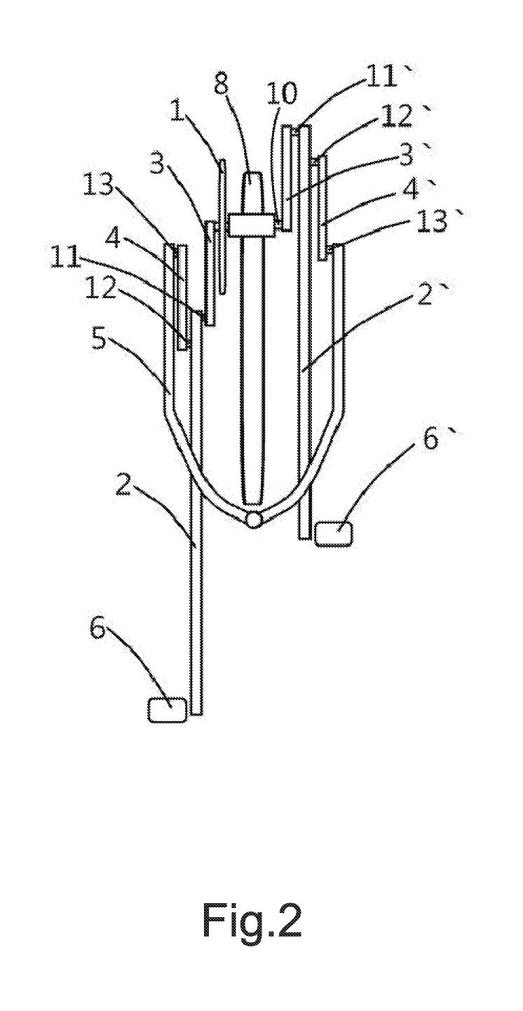

Referring to FIG. 1 and FIG. 2, the present invention provides an effort-saving bicycle. The bicycle comprises a wheel 8. The wheel 8 is centrally mounted with a shaft gear 81 at its rim. The shaft gear 81 is connected to a chain 7. The chain 7 is further connected to a transmission gear 1. The transmission gear 1 has a shaft 10 connected to one end of a first crank 3. The first crank 3 has its opposite end acting as a first crank joint 11. The first crank joint 11 is connected to one end of a link 2 at the link's inner side. The link 2 has its opposite end provided with a pedal 6. The first crank joint 11 of the link 2 has its outer side connected to one end of a second crank 4 through a second crank joint 12. The second crank 4 has its opposite end connected to a second crank-frame joint 13. The second crank-frame joint 13 is connected to a frame 5. The frame 5 has a U-like shape and flanks two sides of the wheel 8. The link 2, the first crank 3, the second crank 4, and the pedal 6 form a set and each of two sides of the wheel 8 is provided with one side set.

With the configuration described above, the link 2 shifts parallelly. When the pedal 6 at the opposite end of the link 2 is pedaled downward, the second crank-frame joint 13 acts as a fulcrum and an action based on the lever rule is activated to rotate the transmission gear 1 and then drive the chain 7 to roll the wheel 8 forward, thereby realizing effort-saving bicycling.

What is claimed is:

1. An effort-saving bicycle, the bicycle comprising at least a wheel, the wheel being centrality provided with a shaft gear at its rim, the shaft gear being connected to a chain, the chain being connected to a transmission gear, the transmission gear having a shaft connected to one end of a first crank, the first crank having an opposite end acting as a first crank joint, the first crank joint being connected to one end of a link at the link's inner side, the link having an opposite end provided with a pedal; the first crank joint of the link having its outer side connected to one end of a second crank through a second crank joint, the second crank having an opposite end connected to a second crank-frame joint, and the second crank-frame joint being connected to a frame.

2. The effort-saving bicycle of claim 1, wherein the link, the first crank, the second crank, and the pedal form a set and each of two sides of the wheel is provided with one side set.

3. The effort-saving bicycle of claim 1, wherein the frame has a roughly U-like shape and flanks two sides of the wheel.

4. The effort-saving bicycle of claim 1, wherein the transmission gear is located at one side and the upper rear of the wheel.
